(19) United States
(12) Patent Application Publication
(10) Pub. No.: US 2023/0063037 A1
(43) Pub. Date: Mar. 2, 2023

(54) Method of Simultaneously Maximizing the Mildness and Cleaning Performance of a Liquid Dishwashing Composition

(71) Applicants: Henkel IP & Holding GmbH, Duesseldorf (DE); Henkel AG & Co. KGaA, Duesseldorf (DE)

(72) Inventors: Meghan Russell, Monroe, CT (US); Dylan Robbins, Stamford, CT (US); Janet Coope-Epstein, Trumbull, CT (US); Marwa Amraoui, Duesseldorf (DE)

(73) Assignees: Henkel IP & Holding GmbH, Duesseldorf (DE); Henkel AG & Co. KGaA, Duesseldorf (DE)

(21) Appl. No.: 17/444,843

(22) Filed: Aug. 11, 2021

(51) Int. Cl. C11D 11/00; C11D 17/00; C11D 1/75; C11D 1/90; C11D 1/14; C11D 3/00; C11D 1/83

(52) U.S. Cl. CPC C11D 11/0035; C11D 17/0008; C11D 1/75; C11D 1/90; C11D 1/146; C11D 3/0047; C11D 1/83

(57) ABSTRACT

A method of simultaneously maximizing the mildness and cleaning performance of a liquid dishwashing composition includes the steps of:
A. forming the composition that has a pH of greater than about 7 and up to about 11, that comprises sodium laureth sulfate, an amine oxide, and optionally cocamidopropyl betaine, and that is substantially free of sodium lauryl sulfate; and
B. subjecting a sample of the composition to a Zein test, a corneosurfametry (CSM) test, and an in vitro cytokine release test for IL-1α response, respectively,

wherein the sample exhibits a Zein score of from about 0.1 to about 2.5, a CSM test value of from about 10 to about 35, and a cytokine release test value of from about 100 to about 600.

### FIELD OF THE INVENTION

The present disclosure generally relates to a method of simultaneously maximizing the mildness and cleaning performance of a liquid dishwashing composition. More specifically, this disclosure relates to a liquid dishwashing composition that has a lower detergent mildness indicator as compared to marketed products.

### BACKGROUND OF THE INVENTION

Many liquid dishwashing compositions contain surfactants to have good cleaning performance. However, such surfactant compositions cause skin and eye irritation. There are several methods to measure the skin irritancy potential of a surfactant composition.

One method to test the skin irritancy potential of a surfactant composition is Zein test. Zein score is measured using a Zein test (Deo et al., Langmuir 2003, 19, 5083-5088). Zein test determines the extent of denaturation of Zein corn protein after exposure to a surfactant for a given period of time. Generally, the higher the Zein score, the greater the skin irritation potential.

Another method to measure the skin irritancy potential is corneosurfametry (CSM) test which is a noninvasive quantitative test that measures the interaction between surfactants and human stratum corneum. (Pierard et al., Dermatology 189: 152-156 (1994)). Corneosurfametry involves removing a few layers of skin using cyanoacrylate skin surface strippings, short contact time with surfactants followed by staining the samples with fuchian dyes. The more irritating the surfactant, the greater the damage to the skin and the greater the penetration of the stain, therefore giving a more intense color, which is measured using colorimetrically with L*a*b* color space. This method is predictive of both protein and lipid damage in the skin. CSM (Corneosurfametry) values are obtained from a corneosurfametry test. In a comparative study, the higher the CSM value, the milder the surfactant composition.

A third method to evaluate the irritation effect of a surfactant composition is measured by cytokine release of representative human skin model in response to the surfactant composition. Where skin tissue viability is not decreased by 50% as compared to the negative control tissue (as measured by MTT reduction), the inflammatory potential is then measured by the production of the cytokines IL-1a and/or IL-1ra. MTT is a dye used to stain the skin cells called 3-(4,5-dimethylthiazol-2-yl)-2,5-diphenyltetrazolium bromide. In a comparative study, a lower cytokine release value means a milder surfactant composition.

Consumers generally prefer mild liquid dishwashing compositions and several products that claim to be mild are currently on the market. However, there remains an opportunity for improvement in developing a liquid dishwashing composition that is mild and yet simultaneously exhibits excellent cleaning properties.

### BRIEF SUMMARY OF THE INVENTION

This disclosure provides a method of simultaneously maximizing the mildness and cleaning performance of a liquid dishwashing composition wherein the method includes the steps of:
A. forming the composition that has a pH of greater than about 7 and up to about 11, that comprises sodium laureth sulfate, an amine oxide, and optionally cocamidopropyl betaine, and that is substantially free of sodium lauryl sulfate; and
B. subjecting a sample of the composition to a Zein test, a corneosurfametry (CSM) test, and an in vitro cytokine release test for IL-1α response, respectively,

wherein the sample exhibits a Zein score of from about 0.1 to about 2.5, a CSM test value of from about 10 to about 35, and a cytokine release test value of from about 100 to about 600.

This disclosure also provides a method of simultaneously maximizing the mildness and cleaning performance of a liquid dishwashing composition, wherein the method includes the steps of:
A. forming the composition that has a pH of from about 3 to about 6, that comprises sodium laureth sulfate and cocamidopropyl betaine, and that is substantially free of sodium lauryl sulfate; and
B. subjecting a sample of the composition to a Zein test, a corneosurfametry (CSM) test, and an in vitro cytokine release test for IL-1α response, respectively,

wherein the sample exhibits a Zein score of from about 0.1 to about 2.5, a CSM test value of from about 10 to about 35, and a cytokine release test value of from about 100 to about 600.

### BRIEF DESCRIPTION OF THE DRAWINGS

The present disclosure will hereinafter be described in conjunction with the following drawing figures, wherein like numerals denote like elements, and

FIG. 1 is a bar graph of Zein Solubilized Percent as a Function of Example, as described in the Examples;

FIG. 2 is a bar graph of CSM test values as a Function of Example, as described in the Examples;

FIG. 3 is a bar graph of Cytokine 1L-1α values as a Function of Example, as described in the Examples; and

FIG. 4 is a bar graph of Scaled DMI values as a Function of Example, as described in the Examples.

### DETAILED DESCRIPTION OF THE INVENTION

The following detailed description is merely exemplary in nature and is not intended to limit the instant methods or compositions. Furthermore, there is no intention to be bound by any theory presented in the preceding background or the following detailed description.

Embodiments of the present disclosure are generally directed to liquid dishwashing compositions and methods for forming the same. For the sake of brevity, conventional techniques related to forming such compositions may not be described in detail herein. Moreover, the various tasks and process steps described herein may be incorporated into a more comprehensive procedure or process having additional steps or functionality not described in detail herein. In particular, various steps in the manufacture of such compositions are well-known and so, in the interest of brevity, many conventional steps will only be mentioned briefly herein or will be omitted entirely without providing the well-known process details.

In one embodiment, this disclosure provides a method of simultaneously maximizing the mildness and cleaning performance of a liquid dishwashing composition wherein the method includes the steps of:
A. forming the composition that has a pH of greater than about 7 and up to about 11, that comprises sodium laureth sulfate, an amine oxide, and optionally cocamidopropyl betaine, and that is substantially free of sodium lauryl sulfate; and
B. subjecting a sample of the composition to a Zein test, a corneosurfametry (CSM) test, and an in vitro cytokine release test for IL-1α response, respectively,

wherein the sample exhibits a Zein score of from about 0.1 to about 2.5, a CSM test value of from about 10 to about 35, and a cytokine release test value of from about 100 to about 600.

In various non-limiting embodiments, all values and ranges of values, both whole and fractional, including and between those set forth above are hereby expressly contemplated for use herein.

In another embodiment, this disclosure also provides a method of simultaneously maximizing the mildness and cleaning performance of a liquid dishwashing composition, wherein the method includes the steps of:
A. forming the composition that has a pH of from about 3 to about 6, that comprises sodium laureth sulfate and cocamidopropyl betaine, and that is substantially free of sodium lauryl sulfate; and
B. subjecting a sample of the composition to a Zein test, a corneosurfametry (CSM) test, and an in vitro cytokine release test for IL-1α response, respectively,

wherein the sample exhibits a Zein score of from about 0.1 to about 2.5, a CSM test value of from about 10 to about 35, and a cytokine release test value of from about 100 to about 600.

In various non-limiting embodiments, all values and ranges of values, both whole and fractional, including and between those set forth above are hereby expressly contemplated for use herein.

In a further embodiment, this disclosure provides a method of simultaneously maximizing the mildness and cleaning performance of a liquid dishwashing composition, the method comprising the steps of:
A. forming the composition that has a pH of greater than about 7 and up to about 11, that consists essentially of sodium laureth sulfate, an amine oxide, and optionally cocamidopropyl betaine, and that is free of sodium lauryl sulfate;
B. subjecting a first sample of the composition to a Zein test, a corneosurfametry (CSM) test, and an in vitro cytokine release test for IL-1α response, respectively,
C. deriving a detergent mildness index (DMI) for the first sample from a sum of standardized Zein score, standardized CSM value, and a standardized cytokine release value, IL-1α of the composition;
D. subjecting a second sample of the composition to a plate count test pursuant to ASTM D4009-92 to determine a plate count score representing cleaning performance; and
E. generating a ratio of DMI:plate count score of less than or equal to about 5.
   In various non-limiting embodiments, all values and ranges of values, both whole and fractional, including and between those set forth above are hereby expressly contemplated for use herein.

In a further embodiment, this disclosure provides a method of simultaneously maximizing the mildness and cleaning performance of a liquid dishwashing composition, the method comprising the steps of:
A. forming the composition that has a pH of from about 3 to about 6, that comprises sodium laureth sulfate and cocamidopropyl betaine, and that is substantially free of sodium lauryl sulfate;
B. subjecting a first sample of the composition to a Zein test, a corneosurfametry (CSM) test, and an in vitro cytokine release test for IL-1α response, respectively,
C. deriving a detergent mildness index (DMI) for the first sample from a sum of standardized Zein score, standardized CSM value, and a standardized cytokine release value, IL-1α of the composition;
D. subjecting a second sample of the composition to a plate count test pursuant to ASTM D4009-92 to determine a plate count score representing cleaning performance; and
E. generating a ratio of DMI:plate count score of less than or equal to about 5.
   In various non-limiting embodiments, all values and ranges of values, both whole and fractional, including and between those set forth above are hereby expressly contemplated for use herein.

This disclosure also provides a liquid dishwashing composition consisting essentially of:
sodium laureth sulfate present in an amount of from about 5 to about 10 weight percent actives based on a total weight of the composition;
lauramine oxide present in an amount of from about 1 to about 5 weight percent actives based on a total weight of the composition; and
cocamidopropyl betaine present in an amount of from 0 to about 1.5 weight percent actives based on a total weight of the composition;
wherein the composition is free of sodium lauryl sulfate;
wherein the composition has:
   a pH of greater than about 7 and up to about 11;
   a detergent mildness index (DMI) of from about 35 to about 40 generated from a sum of standardized Zein score, standardized CSM value, and a standardized cytokine release values IL-1α, of the composition;
   a plate count score of from about 8 to about 10.5 determined pursuant to ASTM D4009-92;
   a Zein score of less than about 0.7%;
   a CSM value of less than about 21;
   a cytokine 1L-1α score of less than about 360; and
   a ratio of DMI:plate count score of less than or equal to about 5.

In various embodiments, the Zein score is from about 0.1 to less than about 0.7%, the CSM test value is from about 10 to less than about 20, and the cytokine release test value is from about 100 to less than about 240. In other embodiments, the Zein score is from about 0.1 to less than about 0.4%, the CSM test value is from about 10 to less than about 20, and the cytokine release test value is from about 100 to less than about 360. In other embodiments, the Zein score is from about 0.1 to less than about 0.6%, the CSM test value is from about 10 to less than about 21, and the cytokine release test value is from about 100 to less than about 260. In various non-limiting embodiments, all values and ranges of values, both whole and fractional, including and between those set forth above are hereby expressly contemplated for use herein.

This disclosure also provides a liquid dishwashing composition consisting of:
sodium laureth sulfate present in an amount of from about 5 to about 10 weight percent actives based on a total weight of the composition;
lauramine oxide present in an amount of from about 1.6 to about 5 weight percent actives based on a total weight of the composition;
cocamidopropyl betaine present in an amount of from 0 to about 1.5 weight percent actives based on a total weight of the composition;
water;
calcium and/or magnesium sulfate;
lauryl ethoxy sulfate comprising about 3 moles of ethylene oxide; and
an amount of citric acid such that the pH of the composition is about 8 to about 10;
wherein the composition has:
   a viscosity of from about 600 to about 1300 cps at about 25° C.;
   a detergent mildness index (DMI) of from about 35 to about 40 generated from a sum of standardized Zein score, standardized CSM value, and a standardized cytokine release value IL-1α, of the composition;
   a plate count score of from about 8 to about 10.5 determined pursuant to ASTM D4009-92; and
   a ratio of DMI:plate count score of less than or equal to about 5.

In various embodiments, the Zein score is from about 0.1 to less than about 0.7%, the CSM test value is from about 10 to less than about 20, and the cytokine release test value is from about 100 to less than about 240. In other embodiments, the Zein score is from about 0.1 to less than about 0.4%, the CSM test value is from about 10 to less than about 20, and the cytokine release test value is from about 100 to less than about 360. In other embodiments, the Zein score is from about 0.1 to less than about 0.6%, the CSM test value is from about 10 to less than about 21, and the cytokine release test value is from about 100 to less than about 260. In various non-limiting embodiments, all values and ranges of values, both whole and fractional, including and between those set forth above are hereby expressly contemplated for use herein.

This disclosure also provides a liquid dishwashing composition consisting essentially of:
sodium laureth sulfate present in an amount of from about 6 to about 13 weight percent actives based on a total weight of the composition; and
cocamidopropyl betaine present in an amount of from 1.5 to about 3.5 weight percent actives based on a total weight of the composition;
wherein the composition is free of sodium lauryl sulfate;
wherein the composition has:
   a pH of from about 3 to about 6;
   a detergent mildness index (DMI) of from about 45 to about 60 generated from a sum of standardized Zein score, standardized CSM value, and a standardized cytokine release values IL-1α, of the composition;
   a plate count score of from about 7 to about 9.5 determined pursuant to ASTM D4009-92;
   a Zein score of less than about 0.7%;
   a CSM value of less than about 21;
   a cytokine 1L-1α score of less than about 360; and
   a ratio of DMI:plate count score of less than or equal to about 5.

In various embodiments, the Zein score is from about 0.1 to less than about 2%, the CSM test value is from about 10 to less than about 36, and the cytokine release test value is from about 100 to less than about 365. In other embodiments, the Zein score is from about 0.1 to less than about 1.3%, the CSM test value is from about 10 to less than about 31, and the cytokine release test value is from about 100 to less than about 377. In further embodiments, the Zein score is from about 0.1 to less than about 0.9%, the CSM test value is from about 10 to less than about 31, and the cytokine release test value is from about 100 to less than about 193. In various non-limiting embodiments, all values and ranges of values, both whole and fractional, including and between those set forth above are hereby expressly contemplated for use herein.

This disclosure also provides a liquid dishwashing composition consisting of:
sodium laureth sulfate present in an amount of from about 5 to about 10 weight percent actives based on a total weight of the composition;
lauramine oxide present in an amount of from about 1.6 to about 5 weight percent actives based on a total weight of the composition;
cocamidopropyl betaine present in an amount of from 0 to about 1.5 weight percent actives based on a total weight of the composition;
water;
calcium and/or magnesium sulfate;
lauryl ethoxy sulfate comprising about 3 moles of ethylene oxide; and
an amount of citric acid such that the pH of the composition is about 8 to about 10;
wherein the composition has:
   a viscosity of from about 600 to about 1300 cps at about 25° C.;
   a detergent mildness index (DMI) of from about 35 to about 40 generated from a sum of standardized Zein score, standardized CSM value, and a standardized cytokine release value IL-1α, of the composition;
   a plate count score of from about 8 to about 10.5 determined pursuant to ASTM D4009-92;
   a Zein score of less than about 0.7%;
   a CSM value of less than about 21;
   a cytokine 1L-1α score of less than about 360; and
   a ratio of DMI:plate count score of less than or equal to about 5.

In various embodiments, the Zein score is from about 0.1 to less than about 2%, the CSM test value is from about 10 to less than about 36, and the cytokine release test value is from about 100 to less than about 365. In other embodiments, the Zein score is from about 0.1 to less than about 1.3%, the CSM test value is from about 10 to less than about 31, and the cytokine release test value is from about 100 to less than about 377. In further embodiments, the Zein score is from about 0.1 to less than about 0.9%, the CSM test value is from about 10 to less than about 31, and the cytokine release test value is from about 100 to less than about 193. In various non-limiting embodiments, all values and ranges of values, both whole and fractional, including and between those set forth above are hereby expressly contemplated for use herein.

### Detergent Mildness Indicator:

This disclosure focuses on simultaneously maximizing the mildness and cleaning performance of a liquid dishwashing composition. The mildness of the composition can be determined based on a detergent mildness indicator (DMI). The DMI can be derived from (1) a Zein score of the composition, a CSM value of the composition, and a cytokine release value IL-1a of the composition. It is contemplated that the terminology “score” and “value” may be used interchangeably herein.

In some embodiments, the Zein test is tested against a 10% dilution of the composition, the corneosurfametric test is tested against a 10% dilution of the composition, and the cytokine release test is tested against a 3% dilution of the composition. Each of these values is described in greater detail below.

### Zein Score:

As used herein the phrase “Zein score” refers the measurement obtained from the Zein test as described below. It can also be referred to as “Zein solubilized %.”

For the Zein test, the liquid hand dish composition which has a total surfactant concentration of about 10%-25%, is diluted to 10% with water. Zein protein is then added to an appropriate amount of the test surfactant solution so that some solids remained undissolved. The mixture is stirred for one hour. Undissolved Zein is then removed by filtration. A 3 mL aliquot of the filtered denatured solution is then analyzed for the weight of solids by drying the solution in an oven at 70° C. The weight of solids in a 3 mL aliquot of the test surfactant solution (in the absence of Zein) is also measured by drying the solution. The quantity of dissolved Zein in the Zein/surfactant solution is then calculated by difference and reported as g Zein/100 g surfactant solution (also called “% Zein” or “Zein score”).

Alternatively, undissolved Zein can be removed by filtration and undissolved solids can be measured gravimetrically. The amount of dissolved Zein remaining in the filtrate is calculated by difference, and reported as g Zein/100 g surfactant solution. In a comparative study, the lower the dissolved Zein, the milder the product.

In various embodiments, the composition may have a Zein score of from about 0.1 to about 2.5, about 0.5 to about 2, about 1 to about 1.5, about 0.2 to about 2.4, about 0.3 to about 2.3, about 0.4 to about 2.2, about 0.5 to about 2.1, about 0.6 to about 2, about 0.7 to about 1.9, about 0.8 to about 1.8, about 0.9 to about 1.7, about 1 to about 1.6, about 1.1 to about 1.5, about 1.2 to about 1.4, or about 1.2 to about 1.3, using any method described above. In some embodiments, the composition has a Zein score of less than about 0.17, 0.20, 0.43, 0.58, 0.69, 0.87, 1.26, 1.93, 1.97, using any method described above. In other embodiments, the composition has a Zein score of from about 0.15 to about 2, about 0.2 to about 2, about 0.4 to about 1.3, about 0.5 to about 0.9, or about 0.5 to about 0.7, using any method described above. In various non-limiting embodiments, all values and ranges of values, both whole and fractional, including and between those set forth above are hereby expressly contemplated for use herein.

### Corneosurfametry (CSM) Test Values:

As used herein, the term CSM refers to the measurement obtained from corneosurfametry test.

In the Corneosurfametry Test, the liquid hand dish composition which has a total surfactant concentration of about 10%-25%, is diluted to 10% with water. Corneosurfametry involves removing a few layers of human skin from the volar forearm of healthy adults using skin surface strippings. The skin is collected with D-Squame tapes (for tests with neutral pH formulas) and with Book tape (for tests with high pH formulas). The tapes are then soaked in the test surfactant solutions for 10 minutes. The tapes are then dried and stained with fuchian dyes for 3 minutes. Once the tapes are dry, they are analyzed with spectrophotometer. L*-C* data can be obtained where L* is lightness and C* is Chroma in color space. The value CSM can be obtained by subtracting L*-C* from 100, that is CSM=100−(L*-C*). Without intending to be bound by theory, it is believed that the higher the CSM value the more damaged the skin.

In various embodiments, the composition may have a CSM test value of from about 10 to about 35, about 15 to about 30, about 20 to about 25, using any method described above. In other embodiments, the composition may have a CSM test value of less than about 17.13, 17.62, 19.27, 19.81, 20.68, 30.89, 31.22, or 35.57, using any method described above. In still other embodiments, the composition may have a CSM test value of from about 17 to about 36, about 17 to about 32, about 19 to about 31, or about 19 to about 21, using any method described above. In various non-limiting embodiments, all values and ranges of values, both whole and fractional, including and between those set forth above are hereby expressly contemplated for use herein.

### Cytokine Release Test Values

As used herein the phrases “cytokine release value” and “cytokine value” are interchangeable and refer to the measurement obtained in in vitro cytokine release test for IL-1a or IL-Ira release as described below.

Relative to an In Vitro Cytokine Release Test, a test surfactant solution can be 3% dilution of a surfactant composition/product which has a total surfactant concentration of about 10%-25%. The EpiDerm Skin Model provided by MatTek Corporation can be used in this test. The target cells are epithelial, derived from human skin. The test surfactant solutions are applied directly to the tissue culture surface, at the air interface, to determine the effect of the surfactant solutions on release of pro-inflammatory cytokines. Where tissue viability is not decreased by 50% as compared to the negative control tissue (as measured by MTT reduction), the inflammatory potential is then measured by the production of the cytokines IL-1α

In the treatment phase six skin equivalents are used for each test solution, and individual results are averaged to provide an overall response. An aliquot of 100 μl of the test solution is applied to each skin equivalent for 1 hour exposure time followed by 5 rinses of Ca and Mg free phosphate buffered saline (PBS) solution. Each tissue is placed in a 6 well tray with assay medium for each rinse and returned to incubation for 24 hours. Following incubation tissues are assessed for cytokine responses of IL-1α. In a comparative study, the lower the cytokine score, the less irritating the product.

In various embodiments, the composition has a cytokine release test value of from about 100 to about 600, about 125 to about 575, about 150 to about 550, about 175 to about 525, about 200 to about 500, about 225 to about 475, about 250 to about 450, about 275 to about 425, about 300 to about 400, about 325 to about 375, or about 350 to about 375, using the method described above. In other embodiments, the composition has a cytokine release test value of less than about 193, 209, 240, 246, 260, 356, 364, or 377, as determined using any method described above. In still other embodiments, the composition has a cytokine release test value of from about 193 to about 377, about 209 to about 364, about 240 to about 356, or about 246 to about 260, as determined using any method described above. In various non-limiting embodiments, all values and ranges of values, both whole and fractional, including and between those set forth above are hereby expressly contemplated for use herein.

In various embodiments, the Zein score is of from about 0.1 to about 1.5, the CSM test value is of from about 15 to about 20, and the cytokine release test value is of from about 100 to about 400. In other embodiments, the Zein score is from about 0.1 to less than about 0.7%, the CSM test value is from about 10 to less than about 20, and the cytokine release test value is from about 100 to less than about 240. In other embodiments, the Zein score is from about 0.1 to less than about 0.4%, the CSM test value is from about 10 to less than about 20, and the cytokine release test value is from about 100 to less than about 360. In other embodiments, the Zein score is from about 0.1 to less than about 0.6%, the CSM test value is from about 10 to less than about 21, and the cytokine release test value is from about 100 to less than about 260. In various embodiments, the Zein score is from about 0.1 to less than about 2%, the CSM test value is from about 10 to less than about 36, and the cytokine release test value is from about 100 to less than about 365. In other embodiments, the Zein score is from about 0.1 to less than about 1.3%, the CSM test value is from about 10 to less than about 31, and the cytokine release test value is from about 100 to less than about 377. In further embodiments, the Zein score is from about 0.1 to less than about 0.9%, the CSM test value is from about 10 to less than about 31, and the cytokine release test value is from about 100 to less than about 193. In various non-limiting embodiments, all values and ranges of values, both whole and fractional, including and between those set forth above are hereby expressly contemplated for use herein.

In various embodiments, for each composition, the Zein score can be measured on 3 replicates, while the corneosurfametry (CSM) L*-C* can be measured on 24 replicates, and levels of cytokines IL-1α and/or IL-1ra can be measured on 3 replicates. In other embodiments, the Zein, CSM and cytokine scores or values are summarized for each composition by computing the average across replicates. Since the units and magnitudes can vary across these measurements, standardized scores for each measure can be calculated in order to create a composite score. The standardized score for a particular composition can be calculated by taking the difference between the composition's observed measure and the overall sample mean and then dividing by the sample standard deviation. In order to be consistent that lower scores indicate a milder product, the reverse sign can be used for the standardized CSM measure.

An overall raw mildness score for a composite mildness indicator can then be calculated as the sum of the standardized Zein, CSM and cytokine IL-1α values. By giving the same weight to each measure, this composite score that each of the measures are equally important.

To better measure the mildness of each composition, a bootstrap mildness index may be used. The bootstrap mildness index can be obtained by a nonparametric bootstrap procedure. To do so, 95% confidence intervals can be constructed and values from the observed replicates are randomly sampled with replacement and the mildness indices were computed based on this bootstrapped data. This process can be repeated and the 2.5 and 97.5 percentiles of the bootstrap mildness index can be taken to be the confidence limits.

### Plate Count Score:

The aforementioned standardized values can then be used in conjunction with a plate count test and plate count score to generate a ratio of DMI:plate count score. Plate count score can be determined using any method in the art wherein soiled dinner plates are washed by hand in solutions of hand dishwashing detergents under standardized conditions until an end point of near-disappearance of the form is reached, wherein the number of plates washed is compared to the number of plates washed using a standard or reference product. In various embodiments, ASTM D4009-92 (reapproved 1997) entitled Standard Guide for Foam Stability of Hand Dishwashing Detergents can be used, as would be understood by those of skill in the art.

Typically, the DMI values used in this ratio are always derived from the standardized Zein scores, CSM test values, and cytokine release test values. In various embodiments, the ratio is less than about 8, 7.5, 7, 6.5, 6, 5.5, 5, 4.5, 4, 3.5, 3, 2.5, 2, 1.5, or 1. Alternatively, the ratios may be from about 3.5 to about 7.5, about 4 to about 7, about 4.5 to about 6.5, about 5 to about 6, or about 5 to about 5.5. In other embodiments, the ratio may be about 3, 3.5, 4, 4.5, 5, 5.5, 6, 6.5, 7, 7.5, or 8. In various non-limiting embodiments, all values and ranges of values, both whole and fractional, including and between those set forth above are hereby expressly contemplated for use herein.

The composition is not limited to any particular viscosity. In various embodiments, the composition has a viscosity of from about 600 to about 1300, about 650 to about 1250, about 700 to about 1200, about 750 to about 1150, about 800 to about 1100, about 850 to about 1050, about 900 to about 1000, or about 950 to about 1000, cPs as determined at about 25° C. Typically, the viscosity is determined using Brookfield viscometer.

### Composition:

The composition itself can be described as a liquid dishwashing composition, a dishwashing composition, etc. In various embodiments, the composition has a pH of from about 3 to about 11, about 3.5 to about 10.5, about 4 to about 10, about 4.5 to about 9.5, about 5 to about 9, about 5.5 to about 8.5, about 6 to about 8, about 6.5 to about 7.5, about 3, 3.5, 4, 4.5, 5, 5.5, 6, 6.5, 7, 7.5, 8, 8.5, 9, 9.5, 10, 10, 10.5, or 11. In other embodiments, the composition has a pH of from about 3 to about 6, about 3.5 to about 5.5, about 4 to about 5, or about 4.5 to about 5. Alternatively, the composition may have a pH of greater than about 7 and up to about 11, about 7.5 to about 11, about 8 to about 10.5, about 8 to about 10, about 8.5 to about 10, or about 9 to about 9.5. In other embodiments, the composition has a pH of greater than about 7, for example greater than about 7 and up to about 11, greater than about 7 and up to about 10, greater than about 7 and up to about 9, greater than about 7 and up to about 8, about 7.5 to about 11.5, about 8 to about 10, about 8.5 to about 9.5, about 8.5 to about 9, about 8 to about 11, or about 9 to about 10. In various non-limiting embodiments, all values and ranges of values, both whole and fractional, including and between those set forth above, are hereby expressly contemplated for use herein.

In one embodiment, the composition comprises sodium laureth sulfate, an amine oxide, and optionally cocamidopropyl betaine, and is substantially free of sodium lauryl sulfate.

In another embodiment, the composition consists essentially of sodium laureth sulfate, an amine oxide, and optionally cocamidopropyl betaine, and is substantially free of sodium lauryl sulfate.

In another embodiment, the composition consists of sodium laureth sulfate, an amine oxide, and optionally cocamidopropyl betaine, and one or more additives as described in this disclosure, and is substantially free of sodium lauryl sulfate.

In one embodiment, the composition comprises sodium laureth sulfate and cocamidopropyl betaine, and is substantially free of sodium lauryl sulfate. This embodiment may be free of an amine oxide.

In another embodiment, the composition consists essentially of sodium laureth sulfate and cocamidopropyl betaine, and is substantially free of sodium lauryl sulfate. This embodiment may be free of an amine oxide.

In another embodiment, the composition consists of sodium laureth sulfate, cocamidopropyl betaine, and one or more additives as described in this disclosure, and is substantially free of sodium lauryl sulfate. This embodiment may be free of an amine oxide.

For example, various compositions may be free of, or include less than about 1, 0.5, or 0.1, weight percent actives of one or more of an amine oxide, sodium lauryl sulfate, alternative surfactants, oxides, additives, acids, etc., or any one or more optional components described herein, based on a total weight of the composition. The terminology “substantially free of” may be further defined as including less than 1, 0.5, or 0.1, weight percent of any compound described above or herein based on a total weight of the composition. In various non-limiting embodiments, all values and ranges of values, both whole and fractional, including and between those set forth above, are hereby expressly contemplated for use herein.

In one embodiment, the composition is free of, or includes less than about 1, 0.5, or 0.1, weight percent actives of, ammonium laureth sulfate and/or sodium pareth sulfate, based on a total weight of the composition. In another embodiment, the composition is free of, or includes less than 10, 9, 8, 7, 6, 5, 4, 3, 2, 1, 0.5, or 0.1, weight percent actives of, an alcohol ethoxylate, based on a total weight of the composition. In another embodiment, the composition is free of, or includes less than 10, 9, 8, 7, 6, 5, 4, 3, 2, 1, 0.5, or 0.1, weight percent actives of, decyl glucoside, based on a total weight of the composition. In another embodiment, the composition is free of, or includes less than 10, 9, 8, 7, 6, 5, 4, 3, 2, 1, 0.5, or 0.1, weight percent actives of, sodium xylene sulfonate, based on a total weight of the composition. It is contemplated that one or more of these “free of” options may apply to any and all compositions described herein in various non-limiting embodiments. In various non-limiting embodiments, all values and ranges of values, both whole and fractional, including and between those set forth above, are hereby expressly contemplated for use herein.

### Sodium Laureth Sulfate:

In various embodiments, the sodium laureth sulfate has the formula CH₃(CH₂)₁₁(OCH₂CH₂)ₙOSO₃Na, wherein n is 1, 2, or 3. The sodium laureth sulfate (SLES) is not particularly limited relative to an amount included in the composition. In various embodiments, the sodium laureth sulfate is present in an amount of from about 1 to about 20, about 2 to about 18, about 3 to about 17, about 4 to about 16, about 5 to about 15, about 6 to about 14, about 7 to about 13, about 8 to about 12, about 9 to about 11, about 10 to about 11, about 5 to about 10, about 6 to about 9, or about 7 to about 8, weight percent actives based on a total weight of the composition. In various embodiments, the sodium laureth sulfate is present in an amount of from about 5.7 to about 12.7 or any amount set forth in the Examples. Notably, it is expressly contemplated that the sodium laureth sulfate may be utilized in any amount described herein independently from the requirements of the other components. In various non-limiting embodiments, all values and ranges of values, both whole and fractional, including and between those set forth above, are hereby expressly contemplated for use herein.

### Amine Oxide:

The amine oxide may be present in the composition or may be absent from the composition. The amine oxide is not particularly limited in type and may be any known in the art. In various embodiments, the amine oxide is chosen from an N,N-dimethyl C10-C16 alkyl amine oxide, a C10-C12 alkyl amidopropyl amine oxide, and combinations thereof. In various embodiments, the N,N-dimethyl C10-C16 alkyl amine oxide may be or include a C10, C11, C12, C13, C14, C15, or C16, alkyl amine oxide or any combination of one or more such oxides.

For example, the N,N-dimethyl C10-C16 alkyl amine oxide may have the following structure wherein “x” is a value of from about 9-15 to about such that a total number of carbon atoms in the alkyl chain is from 10 to 16.

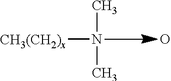

In one embodiment, the N,N-dimethyl C10-C16 alkyl amine oxide is further defined as lauramine oxide, e.g. wherein x=11. In various non-limiting embodiments, all values and ranges of values, both whole and fractional, including and between those set forth above, are hereby expressly contemplated for use herein.

Alternatively, the amine oxide may be or include an alkyl amidopropyl amine oxide, e.g. having the structure below wherein x is from about 10 to about 12, e.g. 10, 11, or 12.

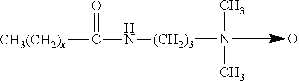

The amine oxide is not particularly limited relative to an amount included in the composition which may be zero or about zero. In various embodiments, the amine oxide is present in an amount of from about 1 to about 20, about 2 to about 18, about 3 to about 17, about 4 to about 16, about 5 to about 15, about 6 to about 14, about 7 to about 13, about 8 to about 12, about 9 to about 11, about 10 to about 11, about 1 to about 5, about 2 to about 4, about 2 to about 3, or about 1.6 to about 5, weight percent actives based on a total weight of the composition. In various embodiments, the amine oxide may be present in any amount set forth in the Examples. Notably, it is expressly contemplated that the amine oxide may be utilized in any amount described herein independently from the requirements of the other components. In various non-limiting embodiments, all values and ranges of values, both whole and fractional, including and between those set forth above, are hereby expressly contemplated for use herein.

In various embodiments, the composition has a pH of from about 3 to about 6 and is, includes, consists essentially of, or consists of, sodium laureth sulfate and cocamidopropyl betaine, and is optionally free of, or includes, amine oxide and/or any additive described herein, and is also substantially free of sodium lauryl sulfate.

In various other embodiments, the composition has a pH of from about 8 to about 10 and is, includes, consists essentially of, or consists of, sodium laureth sulfate and an amine oxide, and is optionally free of, or includes, cocamidopropyl betaine and/or any additive described herein, and is also substantially free of sodium lauryl sulfate.

### Cocamidopropyl Betaine

The cocamidopropyl betaine is optionally present in the composition of this disclosure. Therefore, the betaine may or may not be present. In various embodiments, the composition includes the cocamidopropyl betaine in an amount of about zero or in an amount of from greater than about 0 up to about 10, greater than about 0 up to about 9, greater than about 0 up to about 8, greater than about 0 up to about 7, greater than about 0 up to about 6, greater than about 0 up to about 5, greater than about 0 up to about 4, greater than about 0 up to about 3, greater than about 0 up to about 2, greater than about 0 up to about 1, or greater than about 0 up to about 0.5, weight percent actives based on a total weight of the composition. In other embodiments, the cocamidopropyl betaine is present in an amount of from about 0.5 to about 10, about 1 to about 9.5, about 1.5 to about 9, about 2 to about 8.5, about 2.5 to about 8, about 3 to about 7.5, about 3.5 to about 7, about 4 to about 6.5, about 4.5 to about 6, about 5 to about 5.5, about 0 to about 1.5, about 0 to about 1, about 0 to about 0.5, about 0.5 to about 1.5, about 0.5 to about 1, or about 1 to about 3.33, weight percent actives based on a total weight of the composition. In various embodiments, the betaine may be present in any amount set forth in the Examples. Notably, it is expressly contemplated that the betaine may be utilized in any amount described herein independently from the requirements of the other components. In various non-limiting embodiments, all values and ranges of values, both whole and fractional, including and between those set forth above, are hereby expressly contemplated for use herein.

### Additional Embodiments

Relative to all embodiments below and all embodiments described in this disclosure, all values and ranges of values, both whole and fractional, including and between those set forth herein, are hereby expressly contemplated for use herein in various non-limiting embodiments.

In one embodiment, the sodium laureth sulfate is present in an amount of from about 5 to about 10 weight percent actives based on a total weight of the composition; the lauramine oxide is present in an amount of from about 1 to about 5 weight percent actives based on a total weight of the composition, and the cocamidopropyl betaine is present in an amount of from 0 to about 1.5 weight percent actives based on a total weight of the composition;

In another embodiment, the sodium laureth sulfate is present in an amount of from about 5 to about 10 weight percent actives based on a total weight of the composition, the lauramine oxide is present in an amount of from about 1.6 to about 5 weight percent actives based on a total weight of the composition, and the cocamidopropyl betaine present is present in an amount of from 0 to about 1.5 weight percent actives based on a total weight of the composition.

In one embodiment, the sodium laureth sulfate is present in an amount of from about 5 to about 10 weight percent actives based on a total weight of the composition; the amine oxide is a N,N-dimethyl C10-C16 alkyl amine oxide that is present in an amount of from about 1 to about 5 weight percent actives based on a total weight of the composition; and the cocamidopropyl betaine is present in an amount of from about 1 to about 2 weight percent actives based on a total weight of the composition.

In another embodiment, the composition has a pH of from about 8 to about 10, the sodium laureth sulfate is present in an amount of about 5 to about 6 weight percent actives based on a total weight of the composition; the amine oxide is lauramine oxide and is present in an amount of from about 3 to about 4 weight percent actives based on a total weight of the composition; and the cocamidopropyl betaine is present in an amount of from about 0.5 to about 1.5 weight percent actives based on a total weight of the composition, wherein the composition has a ratio of DMI:plate count score of less than about 4.4, wherein the Zein score is from about 0.1 to less than about 0.2%, wherein the CSM test value is from about 10 to less than about 18, and wherein the cytokine release test value is from about 100 to less than about 210.

In another embodiment, the composition has a pH of from about 8 to about 10, the sodium laureth sulfate is present in an amount of about 8 to about 9 weight percent actives based on a total weight of the composition; the amine oxide is lauramine oxide and is present in an amount of from about 4 to about 5 weight percent actives based on a total weight of the composition; and the cocamidopropyl betaine is present in an amount of from about 1 to about 2 weight percent actives based on a total weight of the composition, wherein the composition has a ratio of DMI:plate count score of less than about 4.4, wherein the Zein score is from about 0.1 to less than about 0.7%, wherein the CSM test value is from about 10 to less than about 20, and wherein the cytokine release test value is from about 100 to less than about 240.

In another embodiment, the sodium laureth sulfate is present in an amount of from about 5 to about 10 weight percent actives based on a total weight of the composition; the amine oxide is chosen from a N,N-dimethyl C10-C16 alkyl amine oxide that is present in an amount of from about 1 to about 5 weight percent actives based on a total weight of the composition; and the composition is free of cocamidopropyl betaine.

In another embodiment, the composition has a pH of from about 8 to about 10, the sodium laureth sulfate is present in an amount of from about 8 to about 9 weight percent actives based on a total weight of the composition; and the amine oxide is lauramine and is present in an amount of from about 1 to about 2 weight percent actives based on a total weight of the composition, wherein the composition has a ratio of DMI:plate count score of less than about 5, wherein the Zein score is from about 0.1 to less than about 0.4%, wherein the CSM test value is from about 10 to less than about 20, and wherein the cytokine release test value is from about 100 to less than about 360.

In still other embodiments, the composition has a pH of from about 8 to about 10, the sodium laureth sulfate is present in an amount of from about 9 to about 10 weight percent actives based on a total weight of the composition; and the amine oxide is lauramine and is present in an amount of from about 4 to about 5 weight percent actives based on a total weight of the composition, wherein the composition has a ratio of DMI:plate count score of less than about 3.6, wherein the Zein score is from about 0.1 to less than about 0.6%, wherein the CSM test value is from about 10 to less than about 18, and wherein the cytokine release test value is from about 100 to less than about 250.

In another embodiment, the composition has a pH of from about 8 to about 10, the sodium laureth sulfate is present in an amount of from about 6 to about 7 weight percent actives based on a total weight of the composition; and the amine oxide is lauramine and is present in an amount of from about 3 to about 4 weight percent actives based on a total weight of the composition, wherein the composition has a ratio of DMI:plate count score of less than about 4.8, wherein the Zein score is from about 0.1 to less than about 0.2%, wherein the CSM test value is from about 10 to less than about 21, and wherein the cytokine release test value is from about 100 to less than about 260.

In another embodiment, the sodium laureth sulfate is present in an amount of from about 10 to about 15 weight percent actives based on a total weight of the composition; and the cocamidopropyl betaine is present in an amount of from about 1 to about 5 weight percent actives based on a total weight of the composition.

In another embodiment, the sodium laureth sulfate is present in an amount of about 12 to about 13 weight percent actives based on a total weight of the composition; the cocamidopropyl betaine is present in an amount of from about 2 to about 3 weight percent actives based on a total weight of the composition, wherein the composition has a ratio of DMI:plate count score of about 7.4, wherein the Zein score is from about 0.1 to less than about 2%, wherein the CSM test value is from about 10 to less than about 36, and wherein the cytokine release test value is from about 100 to less than about 365.

In another embodiment, the sodium laureth sulfate is present in an amount of from about 5 to about 10 weight percent actives based on a total weight of the composition; and the cocamidopropyl betaine is present in an amount of from about 1 to about 5 weight percent actives based on a total weight of the composition.

In another embodiment, the sodium laureth sulfate is present in an amount of about 8 to about 9 weight percent actives based on a total weight of the composition; the cocamidopropyl betaine is present in an amount of from about 1 to about 2 weight percent actives based on a total weight of the composition, wherein the composition has a ratio of DMI:plate count score of about 6.2, wherein the Zein score is from about 0.1 to less than about 1.3%, wherein the CSM test value is from about 10 to less than about 31, and wherein the cytokine release test value is from about 100 to less than about 377.

In a further embodiment, the sodium laureth sulfate is present in an amount of about 6 to about 7 weight percent actives based on a total weight of the composition; the cocamidopropyl betaine is present in an amount of from about 3 to about 4 weight percent actives based on a total weight of the composition, wherein the composition has a ratio of DMI:plate count score of about 6, wherein the Zein score is from about 0.1 to less than about 0.9%, wherein the CSM test value is from about 10 to less than about 31, and wherein the cytokine release test value is from about 100 to less than about 193.

### Additional Components:

In various embodiments, the composition includes, or is free of, an additional component which may be any described below.

For example, the additional component may be a surfactant different from any of the components described above, e.g., one or more nonionic surfactants, anionic surfactants, cationic surfactants, amphoteric surfactants, or combinations thereof. For examples, one or more of these surfactants may be an alcohol ethoxysulfate (AES), a linear alkylbenzenesulfonate (LAS), an alcohol ethoxylate (AE), and/or combinations thereof. In other embodiments, one or more of these surfactants may be a zwitterionic surfactant, a high ethoxylation nonionic surfactant, an alkyl polyglucoside (APG), and/or combinations thereof. Any one or more of these surfactants may be any known in the art of that type. Moreover, one of skill in the art may choose the amount of the additional surfactant to utilize which may be any amount described above, e.g., greater than about zero up to about 20 weight percent actives based on a total weight of the composition or any value or range of values therebetween.

In other embodiments, the composition includes, or is free of, a builder component, for example one chosen from an organic acid, an alkali metal hydroxide, an alkali metal carbonate, an alkali metal bicarbonate, an amine, and combinations thereof. For example, the builder component is chosen from citric acid, sodium carbonate, sodium bicarbonate, sodium hydroxide, calcium chloride, triethanolamine, monoethanolamine, and combinations thereof. Moreover, one of skill in the art may choose the amount of the builder to utilize e.g., zero or greater than about zero up to about 8, about 1 to about 8, about 2 to about 6, or about 4 to about 6, weight percent actives based on a total weight of the composition or any value or range of values therebetween.

In other embodiments, the composition includes, or is free of, a chelator. In some embodiments, the chelator is a polycarboxylic acid. In some embodiments, the polycarboxylic acid is ethylenediaminetetraacetic acid, succinic acid, iminodisuccinic acid, salts thereof, or combinations thereof. Moreover, one of skill in the art may choose the amount of the chelator to utilize e.g., zero or greater than about zero up to about 8, about 1 to about 8, about 2 to about 6, or about 4 to about 6, weight percent actives based on a total weight of the composition or any value or range of values therebetween.

In other embodiments, the composition includes, or is free of, one or more additives chosen from, an enzyme, a color component, a fragrance component, and combinations thereof. In one embodiment, the fragrance component is encapsulated. Moreover, one of skill in the art may choose the amount of the one or more additives to utilize e.g. each independently being zero or greater than about zero up to about 8, about 1 to about 8, about 2 to about 6, or about 4 to about 6, weight percent actives based on a total weight of the composition or any value or range of values therebetween.

In some embodiments, the composition is free of, or includes, a nonionic surfactant (apart from the sodium laureth sulfate) such as an alcohol ethoxylate (AE). In some embodiments, the nonionic surfactant can be an aliphatic primary alcohol ethoxylate. In some embodiments, the ethoxylated nonionic surfactant can be an aliphatic secondary alcohol ethoxylate. In some embodiments, the alcohol ethoxylates can be the condensation products of an organic aliphatic or alkyl aromatic hydrophobic compound and hydrophilic ethylene oxide groups. The length of the polymerized ethylene oxide chain can be adjusted to achieve the desired balance between the hydrophobic and hydrophilic elements. In some embodiments, the nonionic surfactant includes the condensation products of a higher alcohol (e.g., an alkanol containing 8 to 16 carbon atoms in a straight or branched chain configuration) condensed with 4 to 20 moles of ethylene oxide, for example, lauryl or myristyl alcohol condensed with 16 moles of ethylene oxide (EO), tridecanol condensed with 6 moles of EO, myristyl alcohol condensed with 10 moles of EO per mole of myristyl alcohol, the condensation product of EO with a coconut fatty alcohol containing a mixture of fatty alcohols with alkyl chains varying from 10 to 14 carbon atoms in length and wherein the condensate contains either 6 moles of EO per mole of total alcohol or 9 moles of EO per mole of alcohol, and tallow alcohol ethoxylates containing 6 EO to 11 EO per mole of alcohol.

In some embodiments, a higher aliphatic, primary alcohol containing 9-15 carbon atoms, such as C9-C11 alkanol condensed with 4 to 10 moles of ethylene oxide, C12-C13 alkanol condensed with 6.5 moles ethylene oxide (for example, NEODOL 91-8 or NEODOL 9-15 (Shell Chemicals, Netherlands)), C12-C14 alkanol condensed with 12 moles ethylene oxide (for example, NEODOL 25-12 (Shell Chemicals, Netherlands)), C12-C18 alkanol condensed with 9 moles ethylene oxide (for example, NEODOL 25-9 (Shell Chemicals, Netherlands)), C14-C16 alkanol condensed with 13 moles ethylene oxide (for example, NEODOL 45-13 (Shell Chemicals, Netherlands)), or a C12-C14 alkanol condensed with 2, 3, 4, 7, 9, or 10 moles of ethylene oxide, can be used or excluded. In other embodiments, a C12-C14 alkanol condensed with 7 moles of ethylene oxide be used or excluded, e.g. NEODOL 25-7 (Shell Chemicals, Netherlands). Additional satisfactory alcohol ethylene oxide condensates can be the condensation products of a secondary aliphatic alcohol containing 8 to 18 carbon atoms in a straight or branched chain configuration condensed with 5 to 30 moles of ethylene oxide. Examples of commercially available nonionic surfactants of the foregoing type can be C12-C14 secondary alkanol condensed with either 9 EO (TERGITOL™ 15-S-9 (Dow Chemical Company, Michigan, United States)) or 12 EO (TERGITOL™ 15-S-12 (Dow Chemical Company, Michigan, United States)).

In still other embodiments, a methyl ester ethoxylate may be utilized or excluded, e.g. one having the formula RC(═O)(OCH₂CH₂)xOCH₃ where R is an alkyl chain having from 12 to 18 carbon atoms and x is 6, 7, 8, 9, 10, 11, 12, 13, 14, or 15. In certain embodiments, R is an alkyl chain having from 12 to 14 carbon atoms and x is 15. In still other embodiments, R is an alkyl chain having 18 carbon atoms and x is 15. These surfactants are available from Lion Corporation.

Any one or more of these surfactants may be excluded from the composition, used in any amount as described above relative to the sodium laureth sulfate, or be present in an amount of less than about 10, 9, 8, 7, 6, 5, 4, 3, 2, 1, 0.5, or 0.1, weight percent actives based on a total weight of the composition.

In other embodiments, the composition may include or be free of one or more alcohol ethoxysulfate (AES) different from the sodium laureth sulfate. For example, these may be also known as alkyl ether sulfates or alkyl polyethoxylated sulfates, such as those which correspond to the following formula (I):

R′—O—(C₂H₄O)ₙ-SO₃M′ (I)

wherein R′ is a C₈-C₂₀ alkyl group, n is from 1 to 20, and M′ is a salt-forming cation; preferably, R′ is C₁₀-C₁₈ alkyl, n is from 1 to 15, and M′ is sodium, potassium, ammonium, alkylammonium, or alkanolammonium. In another embodiment, R′ is a C₁₂-C₁₆ alkyl, n is from 1 to 6 and M′ is sodium.

The alcohol ethoxysulfate is generally used in the form of mixtures comprising varying R′ chain lengths and varying degrees of ethoxylation. Frequently such mixtures inevitably also include some unethoxylated alkyl sulfate materials, i.e., surfactants of the above ethoxylated alkyl sulfate formula wherein n=0. Unethoxylated alkyl sulfates may also be added separately to the liquid compositions of this disclosure. Suitable unalkoxylated, e.g. unethoxylated, alkyl ether sulfate surfactants are those produced by the sulfation of higher C8-C20 fatty alcohols. Conventional primary alkyl sulfate surfactants have the general formula of: ROSO₃M, wherein R is typically a linear C8-C20 hydrocarbyl group, which may be a straight chain or branched chain, and M is a water-solubilizing cation; preferably R is a C10-C15 alkyl, and M is alkali metal.

Any one or more of these surfactants may be excluded from the composition, used in any amount as described above relative to the sodium laureth sulfate, or be present in an amount of less than about 10, 9, 8, 7, 6, 5, 4, 3, 2, 1, 0.5, or 0.1, weight percent actives based on a total weight of the composition.

In other embodiments, the composition may include or be free of one or more alkylbenzenesulfonates (LAS) are a water soluble salts of a linear alkyl benzene sulfonate having between 8 and 22 carbon atoms in the alkyl group. In one embodiment, the LAS comprises an alkali metal salt of C10-16 alkyl benzene sulfonic acids, such as C11-14 alkyl benzene sulfonic acids. Suitable LAS include sodium and potassium linear, straight chain alkylbenzene sulfonates in which the average number of carbon atoms in the alkyl group is between 11 and 14. Sodium C11-C14, e.g. C12, LAS is one suitable anionic surfactant for use or exclusion herein.

Any one or more of these surfactants may be excluded from the composition, used in any amount as described above relative to the sodium laureth sulfate, or be present in an amount of less than about 10, 9, 8, 7, 6, 5, 4, 3, 2, 1, 0.5, or 0.1, weight percent actives based on a total weight of the composition.

In other embodiments, the composition may include or be free of one or more co-surfactants. In some embodiments, the composition may include or be free of a co-surfactant chosen from a zwitterionic surfactant, a high ethoxylation nonionic surfactant, an alkyl polyglucoside (APG), and any combination thereof.

Zwitterionic surfactants, also known as amphoteric surfactants, have both cationic and anionic centers attached to the same molecule. In certain embodiments, the zwitterionic surfactant can be a betaine having the general structure:

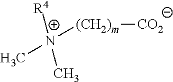

wherein R⁴ is a hydrocarbon chain containing from 8 to 18 carbon atoms, interrupted by an amide group, and m is an integer from 1 to 4. In certain embodiments, R⁴ is R⁵—CONH—(CH₂)ₙ— wherein R⁵ is a linear or branched C8-C18 alkyl group and n is 2, 3, or 4. In some embodiments, R⁵ is a linear C₈-C₁₈ alkyl group and n is 2, 3, or 4. In some embodiments, R⁵ is a linear C₁₁ alkyl group and n is 3 (cocoamidopropyl betaine (“CAPB”)).

A high ethoxylation nonionic surfactant is a nonionic surfactant having a high degree of ethoxylation. Such high ethoxylation nonionic surfactants can include a moiety of (C2H4O)n where n is at least 8, at least 10, at least 12, at least 14, at least 16, at least 18, or at least 20.

In certain embodiments, the composition may include or be free of one or more alkyl polyglucosides (“APG”), or a mixture of alkyl polyglucosides, each having the formula:

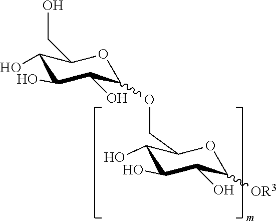

wherein m is an integer from 1 to 10 and R³ is a linear or branched C₈-C₁₈ alkyl group. Alkyl polyglucosides and methods for preparing them are well known in the art. In particular embodiments, the alkyl polyglucoside can be an aqueous mixture of alkyl polyglucosides.

Any one or more of these surfactants may be excluded from the composition, used in any amount as described above relative to the sodium laureth sulfate, or be present in an amount of less than about 10, 9, 8, 7, 6, 5, 4, 3, 2, 1, 0.5, or 0.1, weight percent actives based on a total weight of the composition.

In addition to the components noted above, the composition may also include, or be free of, any one or more ingredients described below such as pH buffering or adjusting agents, builders, metal chelating agents, enzymes, perfumes, colorants, hydrotropes, polyelectrolytes, pearlescers, anti-spotting agents, germicides, fungicides, anti-corrosion agents, crystal growth inhibitors, anti-oxidants, and anti-reducing agents. Examples and sources of suitable such components are well-known in the art and/or are described herein.

For example, in some embodiments, the composition can comprise or be free of a polyol, such as glycerin (glycerol) or propylene glycol, sodium xylene sulfonate, or other hydrotropes. In some embodiments, the composition comprises from about 1% to about 25%, from about 1% to about 20%, from about 1% to about 15%, from about 1% to about 10%, from about 1% to about 5%, or from about 1% to about 2.5% glycerin by weight. In some embodiments, the composition can comprise about 5% or about 2.5% glycerin by weight. In other embodiments, however, the composition can be completely or substantially glycerin free.

The compositions described herein can further include one or more pH adjusting agents. Suitable pH adjusting agents are known to those of ordinary skill in the art but include acids such as hydrochloric acid and bases such as sodium hydroxide, citric acid, triethanolamine, and monoethanolamine. For example, in certain embodiments, the present compositions can include an appropriate amount of one or more pH adjusting agents such that the pH of the composition is as described above.

In certain embodiments, the compositions described herein can include or be free of more than one pH adjusting agent, with each pH adjusting agent present at from about 0.1% to about 5% by weight. In other embodiments, each pH adjusting agent can be present from about 0.1% to about 4% by weight, from about 0.1% to about 3% by weight, from about 0.1% to about 2% by weight or from about 0.1% to about 1% by weight.

In certain embodiments, the composition can comprise at least one of citric acid, sodium hydroxide, and triethanolamine. In certain embodiments, the composition can include citric acid, triethanolamine, and sodium hydroxide.

In certain embodiments, the citric acid can be present at from about 0.5% to about 5% by weight, and in particular embodiments, at about 1% by weight or at about 2% by weight. In some embodiments, the citric acid can be present at about 1.5% by weight. In other embodiments, however, the composition can be completely or substantially citric acid free.

In certain embodiments, the triethanolamine can be present from about 0.5% by weight to about 2% by weight. In certain embodiments, the triethanolamine can be present from about 0.7% by weight to about 1.5% by weight. And in still further embodiments, the triethanolamine can be present at about 1% by weight. In other embodiments, however, the compositions can be completely or substantially triethanolamine free.

Sodium hydroxide, when present, can be added in an amount sufficient to achieve the desired pH. But in certain embodiments, the amount of sodium hydroxide in the composition can range from about 0.5% by weight to about 2% by weight. In still other embodiments, the amount of sodium hydroxide can range from about 0.7% by weight to about 1.5% by weight. In still other embodiments, the amount of sodium hydroxide present in the composition can be about 0.5 to about 0.8% by weight or about 1% by weight to about 2% by weight.

In certain embodiments, the composition can also comprise or be free of a metal chelating agent. Suitable metal chelating agents include polycarboxylic acids such as methyl glycinediacetic acid (MGDA), succinic acid, iminodisuccinic acid (IDS), trisodium ethylenediamine disuccinate (EDDS), pentasodium diethylenetriamine pentatacetate. (DTPA), carboxymethylated polyethyleneimine, ethylenediaminetetrasaceticacid (EDTA), salts of any of the foregoing, and mixture of any of the foregoing.

In certain embodiments, the chelating agent can be present from about 0.01% by weight to about 4.0% by weight. In other embodiments, the chelating agent can be present from about 0.1% to about 2% by weight, or from about 0.2% by weight to about 1% by weight. In other embodiments, the chelating agent can be present at about 0.25% by weight. In one embodiment, the chelating agent can be iminodisuccinic acid.

In certain embodiments, the compositions can also include or be free of one or more biocidal agents such as triclosan (5-chloro-2 (2,4-dichloro-phenoxy) phenol), and the like.

The compositions described herein can further include or be free of an enzyme. Suitable enzymes include those known in the art, such as amylolytic, proteolytic, cellulolytic, or lipolytic type, and those listed in U.S. Pat. No. 5,958,864, the disclosure of which is incorporated herein by reference in its entirety. Also suitable for use in the compositions of the present disclosure can be blends of two or more of these enzymes, for example a protease/lipase blend, a protease/amylase blend, a protease/amylase/lipase blend, and the like. The enzyme can be added in any appropriate amount suitable to achieve its intended purpose. But in certain embodiments, the enzyme can be present from about 0.5% to about 1.5% by weight of the composition, and in certain embodiments at about 0.75% by weight of the composition.

The compositions disclosed herein can optionally include or be free of one or more perfumes or fragrances. As used herein, the term “perfume” can be used in its ordinary sense to refer to, and include, any fragrant substance or mixture of substances including natural (obtained by extraction of flowers, herbs, leaves, roots, barks, wood, blossoms, or plants), artificial (mixture of natural oils or oil constituents), and synthetically produced odoriferous substances. Typically, perfumes can be complex mixtures of blends of various organic compounds such as alcohols, aldehydes, ethers, aromatic compounds and varying amounts of essential oils (e.g., terpenes) such as from 0% to 80%, usually from 1% to 70% by weight, of the essential oils themselves—being volatile odoriferous compounds and also serving to dissolve the other components of the perfume. Suitable perfume ingredients include those disclosed in “Perfume and Flavour Chemicals (Aroma Chemicals)”, published by Steffen Arctander (1969), which can be incorporated herein by reference. In some embodiments, the perfume can be lavender. To the extent a perfume is included in a given composition, from about 0.01% to about 5% by weight of the perfume can be included. In certain embodiments, about 0.75 weight percent perfume can be included in the composition. In other embodiments, however, the composition can be completely or substantially free of perfumes. In some embodiments, the fragrance can be encapsulated in, for example, water-insoluble shell, microcapsule, nanocapsule or any combination thereof.

The compositions herein may further include or be free of one or more preservatives, such as ROCIMA 586 (a mixture of 5-Chloro-2-methyl-4-isothiazolin-3-one (CMIT), 2-Methyl-4-isothiazolin-3-one (MIT), and 2-Bromo-2-nitropropane-1,3-diol (bronopol) sold by The Dow Chemical Company, Midland, Mich.) and/or ACTICIDE CBM2 (a mixture of 5-chloro-2-methyl-4-isothiazolin-3-one, 2-methyl-4-isothiazolin-3-one, and 1,2-benzisothiazolin-3-one, manufactured by THOR GmbH, Speyer, Germany. Also sodium benzoate, sold under the Kalguard trade name from Emerald.

### Method of Simultaneously Maximizing the Mildness and Cleaning Performance:

Referring now to the method itself, the method maximizes the mildness and cleaning performance of the composition. Mildness is typically represented by the DMI score described herein. Moreover, performance is typically represented by the plate count score described herein. One of the goals of this disclosure is to form a composition that is both mild, e.g. having an excellent DMI score, but also effective in cleaning, e.g. having an excellent plate count score. The results set forth herein are both superior to, and unexpected over, what would otherwise be expected in the art such as mildness with inferior cleaning or harshness with superior cleaning.

In one embodiment, the method include the steps of forming the composition that has a pH of greater than about 7 and up to about 11, that comprises sodium laureth sulfate, an amine oxide, and optionally cocamidopropyl betaine, and that is substantially free of sodium lauryl sulfate; and subjecting a sample of the composition to a Zein test, a corneosurfametry (CSM) test, and an in vitro cytokine release test for IL-1α response, respectively, wherein the sample exhibits a Zein score of from about 0.1 to about 2.5, a CSM test value of from about 10 to about 35, and a cytokine release test value of from about 100 to about 600. For example, the Zein score may be of from about 0.1 to about 1.5, the CSM test value may be of from about 15 to about 20, and the cytokine release test value may be of from about 100 to about 400. In one embodiment, the method further includes the step of adjusting components of the composition such that the sample exhibits the Zein score of from about 0.1 to about 2.5, the CSM test value of from about 10 to about 35, and the cytokine release test value of from about 100 to about 600. This may include adjusting the amounts of any one or more of the compounds described in this disclosure.

In one embodiment, the method further includes the steps of: deriving a detergent mildness index (DMI) for the sample from a sum of standardized Zein score, standardized CSM value, and standardized cytokine release value (IL-1α), of the composition; and subjecting a second sample of the composition to a plate count test to determine a plate count score representing cleaning performance; and generating a ratio of DMI:plate count score of less than or equal to about 5. The standardization of these scores/values may be as described above or in the Examples. Similarly, the plate count test, plate count score, and ratio may be as described above.

In one embodiment, the plate count score is determined using ASTM D4009-92, the step of generating the ratio is further defined as calculating the ratio of DMI:plate count score and, if above about 5, reforming the composition such that the ratio is reduced to less than or equal to about 5 and is less than the ratio of DMI:plate count score of a comparative composition that includes a composition of lauramine oxide (2.4%), decyl glucoside (0.4%), sodium lauryl sulfate (12.3%) prepared according to a procedure to make alkaline compositions, as is understood in the art.

This disclosure also provides a method of simultaneously maximizing the mildness and cleaning performance of a liquid dishwashing composition, wherein the method includes the steps of forming the composition that has a pH of from about 3 to about 6, that comprises sodium laureth sulfate and cocamidopropyl betaine, and that is substantially free of sodium lauryl sulfate; and subjecting a sample of the composition to a Zein test, a corneosurfametry (CSM) test, and an in vitro cytokine release test for IL-1α response, respectively, wherein the sample exhibits a Zein score of from about 0.1 to about 2.5, a CSM test value of from about 10 to about 35, and a cytokine release test value of from about 100 to about 600. In various embodiments, the composition is free of an amine oxide. In other embodiments, the Zein score is of from about 0.1 to about 1.5, the CSM test value is of from about 15 to about 20, and the cytokine release test value is of from about 100 to about 400.

In still other embodiments, the method may include the step of adjusting components of the composition such that the sample exhibits the Zein score of from about 0.1 to about 2.5, the CSM test value of from about 10 to about 35, and the cytokine release test value of from about 100 to about 600. This may include adjusting the amounts of any one or more of the compounds described in this disclosure.

In other embodiments, the method includes deriving a detergent mildness index (DMI) for the sample from a sum of standardized Zein score, standardized CSM value, and standardized cytokine release value (IL-1α) of the composition; subjecting a second sample of the composition to a plate count test to determine a plate count score representing cleaning performance; and generating a ratio of DMI:plate count score of less than or equal to about 7.5. The standardization of these scores/values may be as described above or in the Examples. Similarly, the plate count test, plate count score, and ratio may be as described above.

In one embodiment, the plate count score is determined using ASTM D4009-92, the step of generating the ratio is further defined as calculating the ratio of DMI:plate count score and, if above about 7.5, reforming the composition such that the ratio is reduced to less than or equal to about 7.5 and is less than the ratio of DMI:plate count score of a comparative composition that includes a composition of lauramine oxide (2.4%), decyl glucoside (0.4%), sodium lauryl sulfate (12.3%) prepared according to a procedure to make alkaline compositions, as is understood in the art.

In still other embodiments, a method for determining a mild aqueous hand dishwashing formula comprises the following steps: (i) providing a dilute solution of dishwashing liquid; (ii) subjecting dilute solution to three skin care tests: zein test, corneosurfametry test and in vitro cytokine release test for IL-1α; (iii) deriving a detergent mildness index score based on the three skin care tests above. For example, a mild aqueous hand dishwashing formulation may include about 10-15% surfactant wherein the formula has a zein score of less than 2, a corneosurfametry score of less than 36, and a cytokine 1L-1α release score of less than 500. Finally, the composition may have a DMI score which is about 50% of commercial competitor products. The composition may include sodium laureth sulfate (SLES) and either cocamidopropyl betaine (CAPB) or lauramine oxide (amine oxide) or a combination of both and may be substantially free of harsher surfactants linear alkyl benzene sulfonate (LAS) and sodium lauryl sulfate (SLS).

In various non-limiting embodiments, this disclosure may utilize one or more method steps, measurement steps or methods, components, evaluations, etc. as described in U.S. Pat. No. 10,066,190, which is hereby expressly incorporated herein by reference in its entirety relative to these non-limiting embodiments.

### EXAMPLES

### Example 1

Compositions that are representative of various embodiments of this disclosure are formed as set forth in the table below:

| | Surfactant, weight actives % | | | |
|---|---|---|---|---|
| Representative Composition | | | | SXS |
| Acidic Compositions | | | Amine | (post |
| pH ~3-6 | CAPB | SLES | oxide | dose) |
| 2 (15% actives) | 2.3 | 12.7 | 0 | 0 |
| 2 (10% actives) | 1.53 | 8.47 | 0 | 0 |
| 9 (10% actives) | 3.33 | 6.67 | 0 | 0.5 |
| Alkaline Compositions | | | Amine | |
| pH ~8-10 | CAPB | SLES | oxide | SXS |
| 4 (15% actives) | 1.5 | 8.6 | 4.9 | 0 |
| 4 (10% actives) | 1 | 5.73 | 3.27 | 0 |
| 6 (10% actives) | 0 | 8.33 | 1.67 | 0 |
| 7 (15% actives) | 0 | 10 | 5 | 0 |
| 7 (10% actives) | 0 | 6.67 | 3.33 | 0 |

In the table, CAPB = cocamidopropyl betaine; SLES = sodium lauryl ether sulfate; Amine oxide = lauramine oxide; and SXS = sodium xylene sulfonate

### Procedure to Make Acidic Compositions:

Tetrasodium EDTA (0.15%) is added to water, followed by surfactants according to Table with overhead stirring. Citric acid (50%) was used to adjust pH to 4.5. Sodium chloride was added to adjust viscosity to between 600-1300 cPs.

### Preparation of Composition 7

Relative to this Composition, into a 1500 mL beaker is added 681 g deionized water with overhead mixing. Then, 166 g lauramine oxide (30% active in water) is slowly added followed by 9.0 g magnesium sulfate. All the salt is allowed to dissolve before adding 142 g alcohol ethoxy sulfate (70% active in water). The combination is then stirred until dissolved completely. Citric acid solution is added until the pH is about 10. The viscosity should be between 600-1300 cP. Viscosity is adjusted with magnesium sulfate.

### Procedure to Make Alkaline Compositions:

Surfactants were added to water with overhead stirring. Magnesium sulfate is added to adjust viscosity to between 600-1300 cPs. Citric acid (50%) is used to adjust pH to 8.

### Comparative Examples

Comparative Examples A, B, C and D are colorless liquids, free of dyes and are marketed as gentle or mild on hands or for sensitive skin. Comparative Example E is a dish product. The compositions are approximately as follows:

| | Surfactant | | | | | |
|---|---|---|---|---|---|---|
| | | Sodium or | | Sodium or | | |
| | | Ammonium | | Ammonium | | |
| Comparative | | Laureth | Amine | Lauryl | Alcohol | Decyl |
| Examples | CAPB | Sulfate | Oxide | Sulfate | Ethoxylate | Glucoside |
| Comparative | — | x | x | x | x | — |
| Example A | | | | | | |
| Comparative | — | x | x | x | — | — |
| Example B | | | | | | |
| Comparative | — | x | x | x | x | — |
| Example C | | | | | | |
| Comparative | — | — | x | x | — | x |
| Example D | | | | | | |
| Comparative | — | x | x | x | — | — |
| Example E | | | | | | |

In the table, CAPB = cocamidopropyl betaine; Amine oxide = C10-16 alkyl dimethylamine oxide or lauramidopropyl amine oxide; and Alcohol ethoxylate = C9-11 pareth-8 or isodeceth-6.

### Example 2: Composite or Detergent Mildness Indicator

### Mildness Testing

### 1. Zein Test

The test surfactant solution can be a solution with 3% active surfactant, or a 10% dilution of a surfactant formulation/product which has a total surfactant concentration of about 10%-25%. Zein protein was added to an appropriate amount of the test surfactant solution so that some solids remained undissolved. The mixture was stirred for one hour. Undissolved Zein was then removed by filtration. A 3 mL aliquot of the filtered denatured solution was then analyzed for the weight of solids by drying the solution in an oven at 70° C. The weight of solids in a 3 mL aliquot of the test surfactant solution (in the absence of Zein) was also measured by drying the solution. The quantity of dissolved Zein in the Zein/surfactant solution was then calculated by difference and reported as g Zein/100 g surfactant solution (also called “% Zein” or “Zein score”).

Alternatively, undissolved Zein can be removed by filtration and undissolved solids are measured gravimetrically. The amount of dissolved Zein remaining in the filtrate is calculated by difference, and reported as g Zein/100 g surfactant solution. In a comparative study, the lower the dissolved Zein, the milder the product.

### 2. Corneosurfametry Test

The test surfactant solution can be a solution with 3% active surfactant, or a 10% dilution of a surfactant formulation/product which has a total surfactant concentration of about 10%-25%. Corneosurfametry involves removing a few layers of human skin from the volar forearm of healthy adults using skin surface strippings. The skin was collected with D-Squame tapes (for tests with neutral pH formulas) and with Book tape (for tests with high pH formulas). The tapes were then soaked in the test surfactant solutions for 10 minutes. The tapes were then dried and stained with fuchian dyes for 3 minutes. Once the tapes are dry, they were analyzed with spectrophotometer. CSM L*-C* data were obtained. In a comparative study, the higher the CSM L*-C*, the less damaged the skin.

### 3. In Vitro Cytokine Release Test

The test surfactant solution can be 3% dilution of a surfactant formulation/product which has a total surfactant concentration of about 10%-25%. The EpiDerm™ Skin Model provided by MatTek Corporation was used in this test. The target cells were epithelial, derived from human skin. The test surfactant solutions were applied directly to the tissue culture surface, at the air interface, to determine the effect of the surfactant solutions on release of pro-inflammatory cytokines. Where tissue viability was not decreased by 50% as compared to the negative control tissue (as measured by MTT reduction), the inflammatory potential was then measured by the production of the cytokines IL-1α and/or IL-1ra.

In the treatment phase six skin equivalents were used for each test solution, and individual results were averaged to provide an overall response. An aliquot of 100 μl of the test solution was applied to each skin equivalent for 1 hour exposure time followed by 5 rinses of Ca and Mg free phosphate buffered saline (PBS) solution. Each tissue was placed in a 6 well tray with assay medium for each rinse and returned to incubation for 24 hours. Following incubation tissues were assessed for cytokine responses of IL-1α and IL-1ra. In a comparative study, the lower the cytokine score, the less irritating the product.

For each product, the Zein solubilized percentage was measured on 3 replicates, the corneosurfametry (CSM) (100-(L*-C*) was measured on 24 replicates, and levels of cytokines IL-1α and IL-1ra were measured on 3 replicates.

The Zein, CSM and cytokine values were summarized for each product by computing the average across replicates. Since the units and magnitudes vary across these measurements, standardized scores for each measure were calculated in order to create a composite score. The standardized score for a particular product was calculated by taking the difference between the product's observed measure and the overall sample mean and then dividing by the sample standard deviation. In order to be consistent that lower scores indicate a milder product, the reverse sign was used for the standardized CSM measure.

The overall raw mildness score for a composite mildness indicator was calculated as the sum of the standardized Zein, CSM and cytokine values IL-1α values. By giving the same weight to each measure, this composite score that each of the measures are equally important.

To better measure the mildness of each product, bootstrap mildness index may be used. The bootstrap mildness index can be obtained by a nonparametric bootstrap procedure. To do so, 95% confidence intervals were constructed and values from the observed replicates were randomly sampled with replacement and the mildness indices were computed based on this bootstrapped data. This process was repeated and the 2.5 and 97.5 percentiles of the bootstrap mildness index were taken to be the confidence limits.

### Results

### Zein Testing

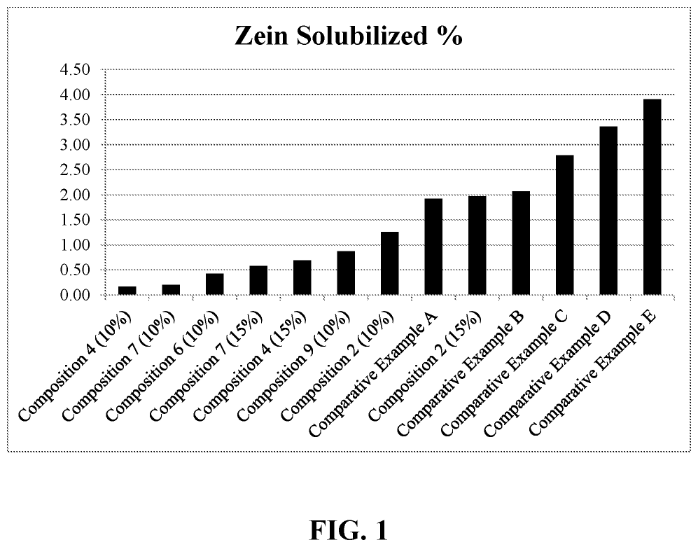

Zein Testing shows that all of the inventive mild compositions of this disclosure are milder than the Comparative Examples B, C, D and E. All inventive compositions except Composition 2 (15%) are milder than Comparative Example A as well. These results are set forth below and in FIG. 1.

| Composition | Zein Solubilized % |
|---|---|
| Composition 4 (10%) | 0.17 |
| Composition 7 (10%) | 0.20 |
| Composition 6 (10%) | 0.43 |
| Composition 7 (15%) | 0.58 |
| Composition 4 (15%) | 0.69 |
| Composition 9 (10%) | 0.87 |
| Composition 2 (10%) | 1.26 |
| Comparative Example A | 1.93 |
| Composition 2 (15%) | 1.97 |
| Comparative Example B | 2.07 |
| Comparative Example C | 2.79 |
| Comparative Example D | 3.36 |
| Comparative Example E | 3.91 |

### Corneosurfametry Testing

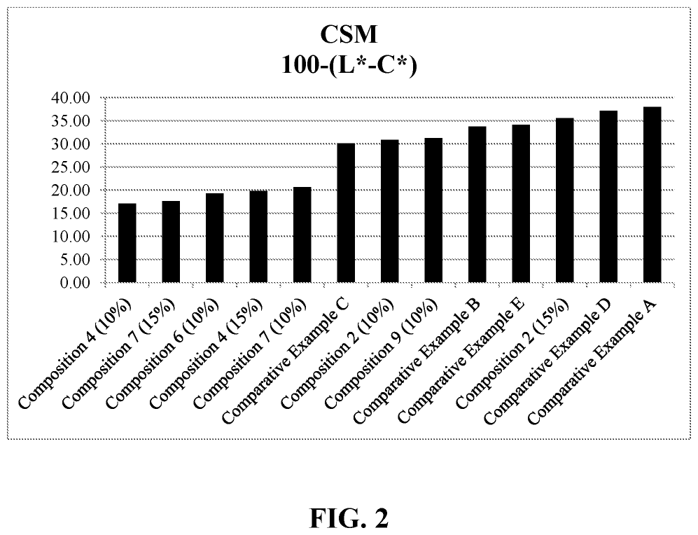

Corneosurfametry Testing shows that Compositions 4, 7 and 6 are the mildest. These results are set forth below and in FIG. 2.

| | CSM |
|---|---|
| Composition | 100-(L*-C*) |
| Composition 4 (10%) | 17.13 |
| Composition 7 (15%) | 17.62 |
| Composition 6 (10%) | 19.27 |
| Composition 4 (15%) | 19.81 |
| Composition 7 (10%) | 20.68 |
| Comparative Example C | 30.10 |
| Composition 2 (10%) | 30.89 |
| Composition 9 (10%) | 31.22 |
| Comparative Example B | 33.75 |
| Comparative Example E | 34.13 |
| Composition 2 (15%) | 35.57 |
| Comparative Example D | 37.19 |
| Comparative Example A | 37.96 |

### Cytokine Testing

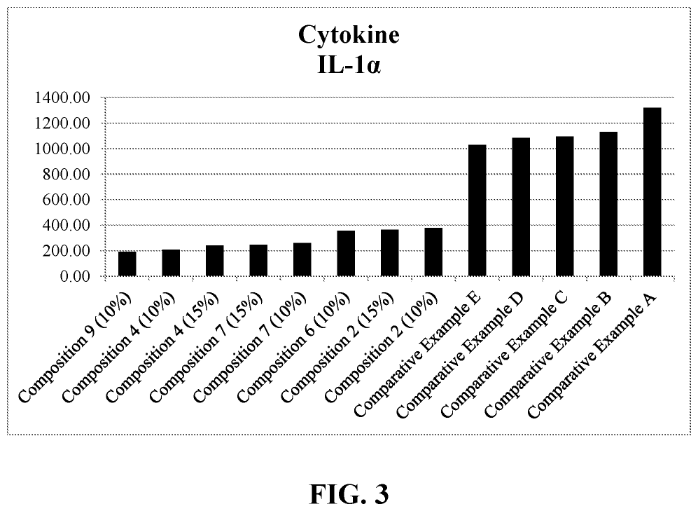

Cytokine Testing shows that all inventive examples are significantly more mild than the commercial Dish compositions A, B, C, D and E. These results are set forth below and in FIG. 3.

| | Cytokine |
|---|---|
| Composition | IL-1α |
| Composition 9 (10%) | 193 |
| Composition 4 (10%) | 209 |
| Composition 4 (15%) | 240 |
| Composition 7 (15%) | 246 |
| Composition 7 (10%) | 260 |
| Composition 6 (10%) | 356 |
| Composition 2 (15%) | 364 |
| Composition 2 (10%) | 377 |
| Comparative Example E | 1029 |
| Comparative Example D | 1085 |
| Comparative Example C | 1096 |
| Comparative Example B | 1131 |
| Comparative Example A | 1322 |

### DMI Calculation

DMI is calculated as follows: DMI=Zein+IL-1α+CSM 100−(L*-C*)

* DMI is scaled to have a mean=50 and standard deviation=15

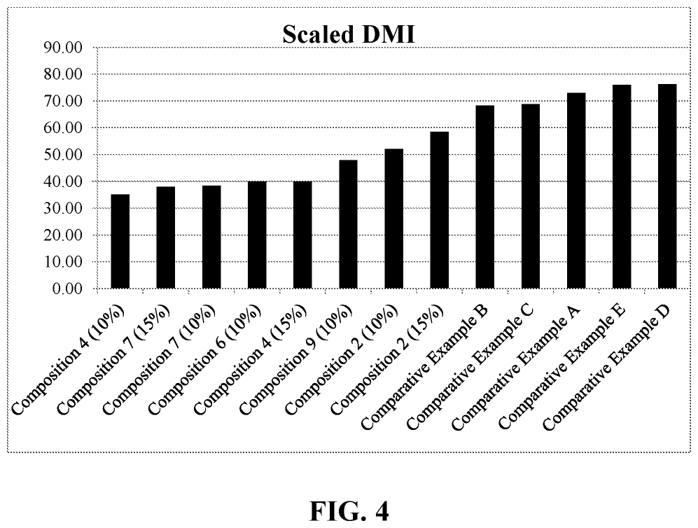

These results show that all inventive Compositions have significantly lower DMI scores than commercial compositions A, B, C, D and E. These results are set forth below and in FIG. 4.

| Composition | DMI-Scaled |
|---|---|
| Composition 4 (10%) | 35.16 |
| Composition 7 (15%) | 38.02 |
| Composition 7 (10%) | 38.45 |
| Composition 6 (10%) | 39.91 |
| Composition 4 (15%) | 39.93 |
| Composition 9 (10%) | 47.86 |
| Composition 2 (10%) | 52.06 |
| Composition 2 (15%) | 58.45 |
| Comparative Example B | 68.26 |
| Comparative Example C | 68.82 |
| Comparative Example A | 73.05 |
| Comparative Example E | 76.02 |
| Comparative Example D | 76.22 |

More specifically, the statistical analysis data is as follows:

| | | | Bootstrap | Bootstrap | % of |
|---|---|---|---|---|---|
| | | Bootstrap | Lower | Upper | Simulations |
| | Observed | Mean | Bound | Bound | Product is |
| DMI | Mildness | Mildness | Mildness | Mildness | Most Mild |
| Composition 4 (10%) | −2.75 | −2.74 | −2.94 | −2.54 | 2% |
| Composition 7 (15%) | −2.22 | −2.21 | −2.44 | −1.97 | 0% |
| Composition 7 (10%) | −2.14 | −2.13 | −2.37 | −1.89 | 0% |
| Composition 6 (10%) | −1.87 | −1.86 | −2.11 | −1.61 | 0% |
| Composition 4 (15%) | −1.87 | −1.86 | −2.07 | −1.64 | 0% |
| Composition 9 (10%) | −0.40 | −0.40 | −0.80 | −0.02 | 0% |
| Composition 2 (10%) | 0.38 | 0.37 | 0.04 | 0.74 | 0% |
| Composition 2 (15%) | 1.57 | 1.56 | 1.23 | 1.90 | 0% |
| Comparative Example B | 3.39 | 3.37 | 2.86 | 3.82 | 0% |
| Comparative Example C | 3.49 | 3.48 | 3.07 | 3.88 | 0% |
| Comparative Example A | 4.28 | 4.25 | 3.93 | 4.59 | 0% |
| Comparative Example E | 4.83 | 4.81 | 4.35 | 5.28 | 0% |
| Comparative Example D | 4.86 | 4.85 | 4.36 | 5.29 | 0% |

### Performance

Performance is measured by a plate count test according to ASTM D4009-92 (reapproved 1997) entitled Standard Guide for Foam Stability of Hand Dishwashing Detergents, as is understood by those of skill in the art.

More specifically, a plate is stained with a composition of 50% Flour, 48% Crisco, 2% oleic acid. The stain mixture (7 g) is applied evenly to the front of a plate and allowed to dry overnight. For washing, a large bowl (16″ diameter, 5.5″ deep) is filled with 100 mL of warm water containing 4 grams of test detergent. A vessel containing 4 L of warm water (117° F.) is dispensed all at once from a bottle suspended 1 ft above the washing bowl. This creates foam on top of the water. A camera is situated directly above the bowl; an image is taken to record the percentage of foam covering the surface area of the water.

To begin the plate washing process, a stained plate is placed ¾ of the way into the wash water. Plate is rubbed with a rag in a circular motion, scrubbing a plate to wash the stain off. Rubbing motion continues for 30 seconds. The plate is rinsed with dish basin water. An image is captured to record a photo of the remaining foam and gives a percent covering the surface area of the water.

This process continues wherein new plates are changed every time until the foam covering is less than 50%. As surfactants in the compositions complex with the soil, the foam disappears. This is a signal for the consumer that the solution is no longer effective for cleaning dishes. The higher the plate count, the longer the foam longevity and the higher the cleaning.

The results of the plate count evaluations are set forth below. For context, a leading value dish detergent has a plate count of 7.5 in this test. This value of 7.5 can be considered the lower value desired to achieve good consumer acceptability of the product. The data shows that the mild formulas of this disclosure all have plate counts close at or above 7.5 and hence have acceptable cleaning.

| Composition | Plate count (average of 2 runs) |
|---|---|
| Composition 2 (15%) | 9.5 |
| Composition 2 (10%) | 7 |
| Composition 9 (10%) | 8 |
| Composition 4 (15%) | 9 |
| Composition 4 (10%) | 8 |
| Composition 6 (10%) | 8 |
| Composition 7 (15%) | 10.5 |
| Composition 7 (10%) | 8 |
| Comparative Example E | 15 |
| Comparative Example C | 12 |
| Comparative Example A | 11.5 |
| Comparative Example B | 11 |
| Comparative Example D | 11.5 |

### Mildness/Plate Count Ratio

The cleaning of soiled dishes in a home setting with of liquid dish detergent typically involves filling a sink with water, adding detergent, and the scrubbing the dish with a sponge/cloth while submerging the dish in the soapy water. During this process of cleaning dishes, the user's hands and forearms come in direct and sustained exposure to the diluted detergent causing dermal irrational, particularly so if the user suffers from a sensitive skin condition. As more soiled dishes are wash in the sink water, suspended soil causes the surface foam/suds to break and this is often a signal to the consumer to add more detergent. The extra detergent in the wash water increases the surfactant exposure on the skin and further exacerbates irritation.

An ideal liquid hand soap for sensitive skin users is both mild (as indicated by a low DMI score) and has a prolonged foam stability (as indicated by a high plate count score) because less detergent comes in contact with the skin and the unavoidable exposure is inherently low irritation. This sought after quality of liquid dish detergents can be evaluated by calculating ratio between DMI and plate count. DMI/plate count can be thought of as an indication for the amount of irritation that may result from cleaning one plate. Thus, it is desirable to have a low value for the ratio of DMI/plate count when formulating a sensitive-skin soap.

The table below provides the ratio of DMI/plate count as determined in these Examples. Despite the diversity of formulations which were tested, all of the Comparative Examples and some of the Inventive Compositions did not achieve a DMI/plate count values lower than 5.0. These results are expected because while it is known that including good cleaning surfactants such as SLS will improve plate count, these surfactants are also known to be harsh on skin. Unexpectedly, Inventive formulas 4 (10% & 15%) and 7 (10% & 15%) achieved remarkably low DMI/plate count values, between 4.8 and 3.6. Compositions such as these are significantly milder on skin for the amount of cleaning they can achieve when compared to any of the five commercial formulas.

| | | Plate count | Ratio |
|---|---|---|---|
| | | (average of 2 | DMI/plate |
| Composition | DMI | runs) | count |
| Composition 2 | 58.45 | 9.5 | 6.2 |
| (15%) | | | |
| Composition 2 | 52.06 | 7 | 7.4 |
| (10%) | | | |
| Composition 9 | 47.86 | 8 | 6.0 |
| (10%) | | | |
| Composition 4 | 39.93 | 9 | 4.4 |
| (15%) | | | |
| Composition 4 | 35.16 | 8 | 4.4 |
| (10%) | | | |
| Composition 6 | 39.91 | 8 | 5.0 |
| (10%) | | | |
| Composition 7 | 38.02 | 10.5 | 3.6 |
| (15%) | | | |
| Composition 7 | 38.45 | 8 | 4.8 |
| (10%) | | | |
| Comparative | 33.85 | 15 | 5.1 |
| Example E | | | |
| Comparative | 68.82 | 12 | 5.7 |
| Example C | | | |
| Comparative | 73.05 | 11.5 | 6.4 |
| Example A | | | |
| Comparative | 68.26 | 11 | 6.2 |
| Example B | | | |
| Comparative | 76.22 | 11.5 | 6.6 |
| Example D | | | |

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A method of simultaneously maximizing the mildness and cleaning performance of a liquid dishwashing composition, said method comprising the steps of:
A. forming the composition that has a pH of greater than about 7 and up to about 11, that comprises sodium laureth sulfate, an amine oxide, and optionally cocamidopropyl betaine, and that is substantially free of sodium lauryl sulfate; and
B. subjecting a sample of the composition to a Zein test, a corneosurfametry (CSM) test, and an in vitro cytokine release test for IL-1α response, respectively,
wherein the sample exhibits a Zein score of from about 0.1 to about 2.5, a CSM test value of from about 10 to about 35, and a cytokine release test value of from about 100 to about 600.

2. The method of claim 1, wherein the Zein score is of from about 0.1 to about 1.5, the CSM test value is of from about 15 to about 20, and the cytokine release test value is of from about 100 to about 400.

3. The method of claim 1, further comprising the step of adjusting components of the composition such that the sample exhibits the Zein score of from about 0.1 to about 2.5, the CSM test value of from about 10 to about 35, and the cytokine release test value of from about 100 to about 600.

4. The method of claim 1, further comprising the steps of:
C. deriving a detergent mildness index (DMI) for the sample from a sum of standardized Zein score, standardized CSM value, and standardized cytokine release value (IL-1α), of the composition;
D. subjecting a second sample of the composition to a plate count test to determine a plate count score representing cleaning performance; and
E. generating a ratio of DMI:plate count score of less than or equal to about 5.

5. The method of claim 4, wherein the plate count score is determined using ASTM D4009-92, the step of generating the ratio is further defined as calculating the ratio of DMI:plate count score and, if above about 5, reforming the composition such that the ratio is reduced to less than or equal to about 5 and is less than the ratio of DMI:plate count score of a comparative composition of lauramine oxide (2.4%), decyl glucoside (0.4%), and sodium lauryl sulfate (12.3%).

6. The method of claim 4, wherein:
the sodium laureth sulfate is present in an amount of from about 5 to about 10 weight percent actives based on a total weight of the composition;
the amine oxide is a N,N-dimethyl C10-C16 alkyl amine oxide that is present in an amount of from about 1 to about 5 weight percent actives based on a total weight of the composition; and
the cocamidopropyl betaine is present in an amount of from about 1 to about 2 weight percent actives based on a total weight of the composition.

7. The method of claim 6, wherein
the composition has a pH of from about 8 to about 10,
the sodium laureth sulfate is present in an amount of about 5 to about 6 weight percent actives based on a total weight of the composition;
the amine oxide is lauramine oxide and is present in an amount of from about 3 to about 4 weight percent actives based on a total weight of the composition; and
the cocamidopropyl betaine is present in an amount of from about 0.5 to about 1.5 weight percent actives based on a total weight of the composition,
wherein the composition has a ratio of DMI:plate count score of less than about 4.4,
wherein the Zein score is from about 0.1 to less than about 0.2%,
wherein the CSM test value is from about 10 to less than about 18, and
wherein the cytokine release test value is from about 100 to less than about 210.

8. The method of claim 6, wherein
the composition has a pH of from about 8 to about 10,
the sodium laureth sulfate is present in an amount of about 8 to about 9 weight percent actives based on a total weight of the composition;
the amine oxide is lauramine oxide and is present in an amount of from about 4 to about 5 weight percent actives based on a total weight of the composition; and
the cocamidopropyl betaine is present in an amount of from about 1 to about 2 weight percent actives based on a total weight of the composition,
wherein the composition has a ratio of DMI:plate count score of less than about 4.4,
wherein the Zein score is from about 0.1 to less than about 0.7%,
wherein the CSM test value is from about 10 to less than about 20, and
wherein the cytokine release test value is from about 100 to less than about 240.

9. The method of claim 4, wherein
the sodium laureth sulfate is present in an amount of from about 5 to about 10 weight percent actives based on a total weight of the composition;
the amine oxide is chosen from a N,N-dimethyl C10-C16 alkyl amine oxide that is present in an amount of from about 1 to about 5 weight percent actives based on a total weight of the composition; and
the composition is free of cocamidopropyl betaine.

10. The method of claim 9, wherein
the composition has a pH of from about 8 to about 10,
the sodium laureth sulfate is present in an amount of from about 8 to about 9 weight percent actives based on a total weight of the composition; and
the amine oxide is lauramine and is present in an amount of from about 1 to about 2 weight percent actives based on a total weight of the composition,
wherein the composition has a ratio of DMI:plate count score of less than about 5,
wherein the Zein score is from about 0.1 to less than about 0.4%,
wherein the CSM test value is from about 10 to less than about 20, and
wherein the cytokine release test value is from about 100 to less than about 360.

11. The method of claim 9, wherein
the composition has a pH of from about 8 to about 10,
the sodium laureth sulfate is present in an amount of from about 9 to about 10 weight percent actives based on a total weight of the composition; and
the amine oxide is lauramine and is present in an amount of from about 4 to about 5 weight percent actives based on a total weight of the composition,
wherein the composition has a ratio of DMI:plate count score of less than about 3.6,
wherein the Zein score is from about 0.1 to less than about 0.6%,
wherein the CSM test value is from about 10 to less than about 18, and
wherein the cytokine release test value is from about 100 to less than about 250.

12. The method of claim 9, wherein:
the composition has a pH of from about 8 to about 10,
the sodium laureth sulfate is present in an amount of from about 6 to about 7 weight percent actives based on a total weight of the composition; and
the amine oxide is lauramine and is present in an amount of from about 3 to about 4 weight percent actives based on a total weight of the composition,
wherein the composition has a ratio of DMI:plate count score of less than about 4.8,
wherein the Zein score is from about 0.1 to less than about 0.2%,
wherein the CSM test value is from about 10 to less than about 21, and
wherein the cytokine release test value is from about 100 to less than about 260.

13. The method of claim 1 wherein
the Zein score is from about 0.1 to less than about 0.7%,
the CSM test value is from about 10 to less than about 20, and
the cytokine release test value is from about 100 to less than about 240.

14. The method of claim 1, wherein
the Zein score is from about 0.1 to less than about 0.4%,
the CSM test value is from about 10 to less than about 20, and
the cytokine release test value is from about 100 to less than about 360.

15. The method of claim 1, wherein
the Zein score is from about 0.1 to less than about 0.6%,
the CSM test value is from about 10 to less than about 21, and
the cytokine release test value is from about 100 to less than about 260.

16. The method of claim 4, wherein the composition has a ratio of DMI:plate count score of from about 3.6 to about 5.

17. A method of simultaneously maximizing the mildness and cleaning performance of a liquid dishwashing composition, said method comprising the steps of:
A. forming the composition that has a pH of from about 3 to about 6, that comprises sodium laureth sulfate and cocamidopropyl betaine, and that is substantially free of sodium lauryl sulfate; and
B. subjecting a sample of the composition to a Zein test, a corneosurfametry (CSM) test, and an in vitro cytokine release test for IL-1α response, respectively,
wherein the sample exhibits a Zein score of from about 0.1 to about 2.5, a CSM test value of from about 10 to about 35, and a cytokine release test value of from about 100 to about 600.

18. The method of claim 17, wherein the composition is free of an amine oxide.

19. The method of claim 17, wherein the Zein score is of from about 0.1 to about 1.5, the CSM test value is of from about 15 to about 20, and the cytokine release test value is of from about 100 to about 400.

20. The method of claim 17, further comprising the step of adjusting components of the composition such that the sample exhibits the Zein score of from about 0.1 to about 2.5, the CSM test value of from about 10 to about 35, and the cytokine release test value of from about 100 to about 600.
